(19) United States
(12) Patent Application Publication
(10) Pub. No.: US 2017/0124912 A1
(43) Pub. Date: May 4, 2017

(54) MOBILE DEVICE CASE WITH SCALE

(71) Applicant: ICON Health & Fitness, Inc., Logan, UT (US)

(72) Inventors: Darren C. Ashby, Richmond, UT (US); Scott R. Watterson, Logan, UT (US)

(21) Appl. No.: 15/340,658

(22) Filed: Nov. 1, 2016

Related U.S. Application Data
(60) Provisional application No. 62/250,868, filed on Nov. 4, 2015.

(51) Int. Cl. G09B 19/00; G01G 19/52

(52) U.S. Cl. CPC G09B 19/0092; G01G 19/52

(57) ABSTRACT

A mobile device case includes a back wall, a first side wall transversely connected to the back wall, a second side wall transversely connected to the back wall opposite the first side wall, an attachment feature integrated into at least one of the first side wall and the second side wall to connect the mobile device case to a mobile device, and a weight scale integrated into at least one of the back wall, the first side wall, and the second side wall.

### RELATED APPLICATIONS

This application claims priority to U.S. Patent Application Ser. No. 62/250,868 titled “Mobile Device Case with Scale” and filed on Nov. 4, 2015, which application is herein incorporated by reference for all that it discloses.

### BACKGROUND

Those trying to lose weight often track the number of calories that they consume during a day. The goal is to consume less calories than calories that are burned through exercise and daily body maintenance. Having a deficit of calories in a day is linked to weight loss. On the other hand, body builders and some athletes desire to gain muscle. Thus, they try to eat more calories than they burn during a day. The excess calories are believed to contribute to muscle gain when an individual executes appropriate workouts.

To track the number of calories eaten in a day, a user often looks at labels on food packaging and determine the amount of the food that he or she can eat. If no calorie information is listed on the food packaging, the user may search the internet or look at publications to determine or estimate the amount of calories in the food that he or she is eating.

One type of tool for tracking calories is described in U.S. Patent Publication No. 2007/0050058 issued to Zbigniew Zuzlak. In this reference, a placemat is disclosed having a scale, a calorie calculator, a memory for storing calorie and other nutritive intake history, and an interface that allows for communication and synchronization with outside computer entities.

### SUMMARY

In one embodiment, a mobile device case includes a back wall, a first side wall transversely connected to the back wall, a second side wall transversely connected to the back wall opposite the first side wall, an attachment feature integrated into at least one of the first side wall and the second side wall to connect the mobile device case to a mobile device, and a weight scale integrated into at least one of the back wall, the first side wall, and the second side wall.

The mobile device case may further include a transmitter to communicate with the mobile device.

The mobile device case may include a memory and a processor where the memory includes programmed instructions to cause the processor to send a weight measured with the weight scale to the mobile device.

The programmed instructions may cause the processor to receive a food type from the mobile device.

The programmed instructions may cause the processor to multiply a measured weight with a calorie amount associated with the food type to determine a calorie count.

The programmed instructions may cause the processor to send a notification based one the calorie count.

The notification may suggest that a user modify an amount of food being measured with the weight scale.

The programmed instructions may cause the processor to send a warning to the mobile device when a weight measured with the weight scale and associated with an alcoholic beverage exceeds a predetermined weight.

The mobile device case may include a thermal insulating material incorporated into the back wall.

The mobile device case may further include a water resistant encapsulating material surrounding the weight scale.

In one embodiment, a method for determining an indigested amount of calories may include receiving an input identifying a food type into a mobile device, receiving a container of food on the mobile device where the mobile device is attached to a case that incorporates a weight scale, measuring a before measurement of a weight of the container of the food with the weight scale before eating at least a portion of the food, and measuring an after measurement of the weight of the container of the food with the weight scale after eating the at least portion of the food.

The method may include determining a difference between the weight of the food before and after eating.

The method may include multiplying the difference by a calorie amount associated with the food type to determine a calorie count.

The method may include communicating a notification based on the calorie count.

The method may include communicating a warning when the calorie count exceeds a predetermined threshold when the food type is an alcoholic beverage.

In one embodiment, a mobile device may include a case, a weight scale integrated into the case, a scale transmitter in communication with the weight scale, and a mobile device transmitter in communication with memory and a processor of the mobile device. The memory includes programmed instructions that cause the processor to receive an input of identifying a food type into a mobile device, receive a container of food on the mobile device where the mobile device is attached to a case that incorporates a weight scale, receive a before measurement of a weight of the container of the food with the weight scale before eating at least a portion of the food, and receive an after measurement of the weight of the container of the food with the weight scale after eating the at least portion of the food.

The mobile device case may include a thermal insulating material incorporated into the case.

The mobile device case may include a water resistant encapsulating material surrounding the case.

### BRIEF DESCRIPTION OF THE DRAWINGS

The accompanying drawings illustrate various embodiments of the present apparatus and are a part of the specification. The illustrated embodiments are merely examples of the present apparatus and do not limit the scope thereof.

FIG. 1 illustrates a side perspective view of an example of a case for a mobile device in accordance with the present disclosure.

FIG. 2 illustrates a cross sectional view of an example of a case for a mobile device in accordance with the present disclosure.

FIG. 3 illustrates an example of a display of a mobile device in accordance with the present disclosure.

FIG. 4 illustrates an example of a display of a mobile device in accordance with the present disclosure.

FIG. 5 illustrates a side view of an example of case of a mobile device in accordance with the present disclosure.

FIG. 6 illustrates an example of a display of a mobile device in accordance with the present disclosure.

FIG. 7 illustrates an example of a tracking system in accordance with the present disclosure.

Throughout the drawings, identical reference numbers designate similar, but not necessarily identical, elements.

### DETAILED DESCRIPTION

For purposes of this disclosure, the term “aligned” means parallel, substantially parallel, or forming an angle of less than 35.0 degrees. For purposes of this disclosure, the term “transverse” means perpendicular, substantially perpendicular, or forming an angle between 55.0 and 125.0 degrees. Also, for purposes of this disclosure, the term “length” means the longest dimension of an object. Also, for purposes of this disclosure, the term “width” means the dimension of an object from side to side. For the purposes of this disclosure, the term “above” generally means superjacent, substantially superjacent, or higher than another object although not directly overlying the object. Further, for purposes of this disclosure, the term “mechanical communication” generally refers to components being in direct physical contact with each other or being in indirect physical contact with each other where movement of one component affect the position of the other.

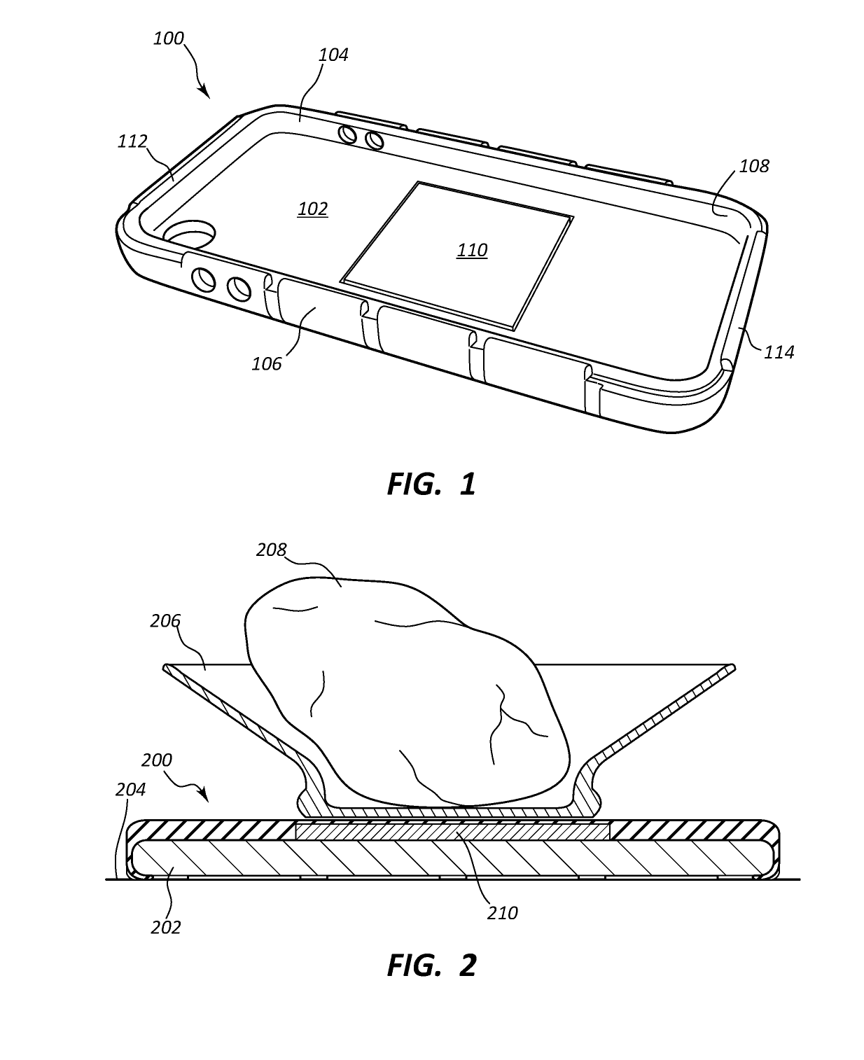

Particularly, with reference to the figures, FIG. 1 depicts an example of a case 100 for a mobile device. In this example, the case 100 includes a back wall 102, a first side wall 104 transversely connected to the back wall 102, and a second side wall 106 transversely connected to the back wall 102 opposite the first side wall 104. The case 100 also includes an attachment feature 108 integrated into at least one of the first side wall 104 and the second side wall 106 to connect the mobile device case 100 to a mobile device. Also, a weight scale 110 is integrated into at least one of the back wall 102, the first side wall 104, and the second side wall 106.

In this example, the case 100 also include a third side wall 112 transversely connected to the back wall 102, and a fourth side wall 114 transversely connected to the back wall 102 opposite the third side wall 112. In this example, the weight scale 110 may be incorporated into any part of the case 100 including the back wall, 102, the first side wall 104, the second side wall 106, the third side wall 112, and the fourth side wall 114.

FIG. 2 depicts an example of case 200 for a mobile device 202. In this example, the case 200 is attached to the mobile device 202. The mobile device 202 is facing downward on a surface 204 that supports the mobile device 202. In this situation, the back side 204 of the case 200 is upward. A bowl 206 containing a potato 208 is placed on the backside of the case 200. The weight from the bowl 206 and the potato 208 is loaded to the weight scale 210 integrated into the case's back side 204.

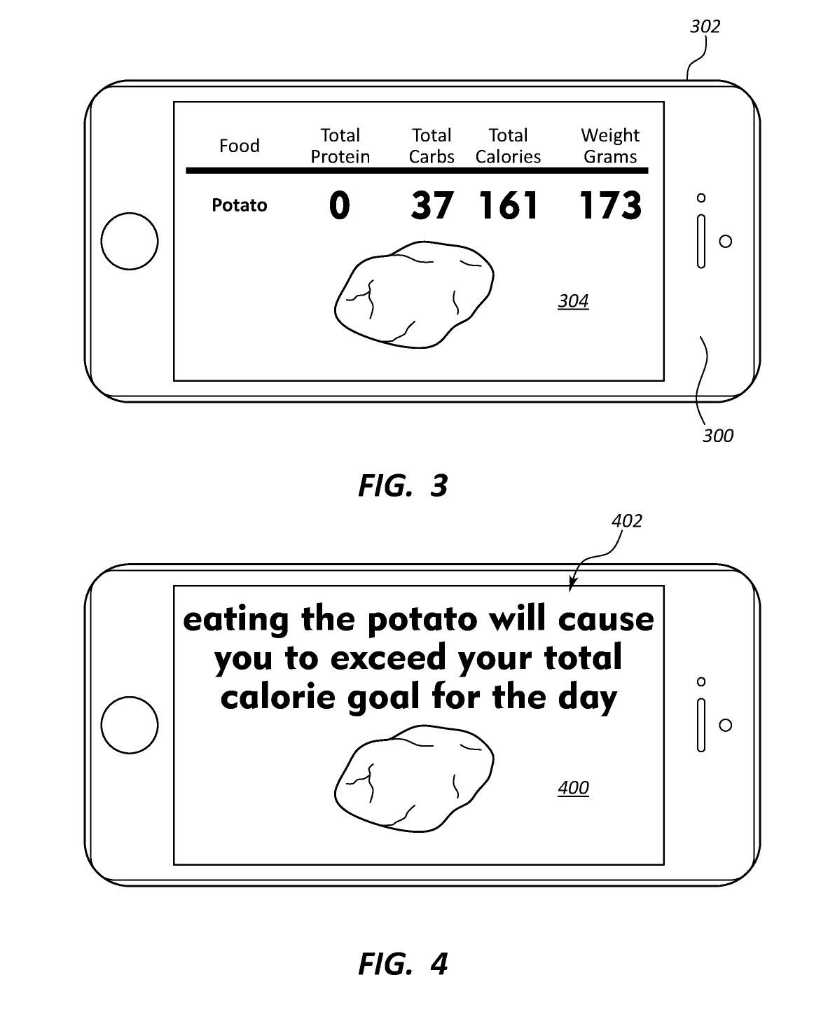

FIG. 3 depicts an example of mobile device 300 in a case 302. In this example, the mobile device 300 includes a display 304 that presents information that was transmitted from the weight scale to the mobile device 300. In this example, the information that was transmitted includes a weight.

In some cases, the information is also provided into the mobile device 300 by the user. For example, the user may identify the type of food being measured. In this example, the user may indicate that the food being measured is a potato. Based on the identified food type, the mobile device 300 may determine other types of data about the food. In this instance, the display 304 presents the total amount of protein, carbohydrates, and calories that are associated with measured weight of the potato. In this example, an image of the potato is also depicted in the display 304. In other examples, more information and/or less information about the measured food is depicted in the display 304.

While this example has been described with the mobile device 300 determining the additional data about the measured food, in some examples, the case includes a processor that can gather the additional information about the measured food. In this example, the mobile device 300 may transmit the identified food type to the case and the case may process the additional data. In yet other examples, the case includes logic that can determine the food type without a message from the mobile device 300.

In some examples, the weight of the potato is calculated by subtracting the weight of the bowl or other type of container on which the food is contained. In one of these cases, the user can send a calibrate command to the weight scale when just the container is placed on the case 302 without food. The calibrate command may be sent through an input button integrated into the case 302, through a verbal command, through another type of command, or combinations thereof. In another example, the weight of the container can be measured separately, and the user inputs the weight of the plate. In yet other examples, the user measures the total weight of the container and all the food in the container before eating. After eating the weight scale can determine the remaining weight, which can include the container's weight and the weight of any uneaten food. The difference between the initial weight and the remaining weight can be consumed weight.

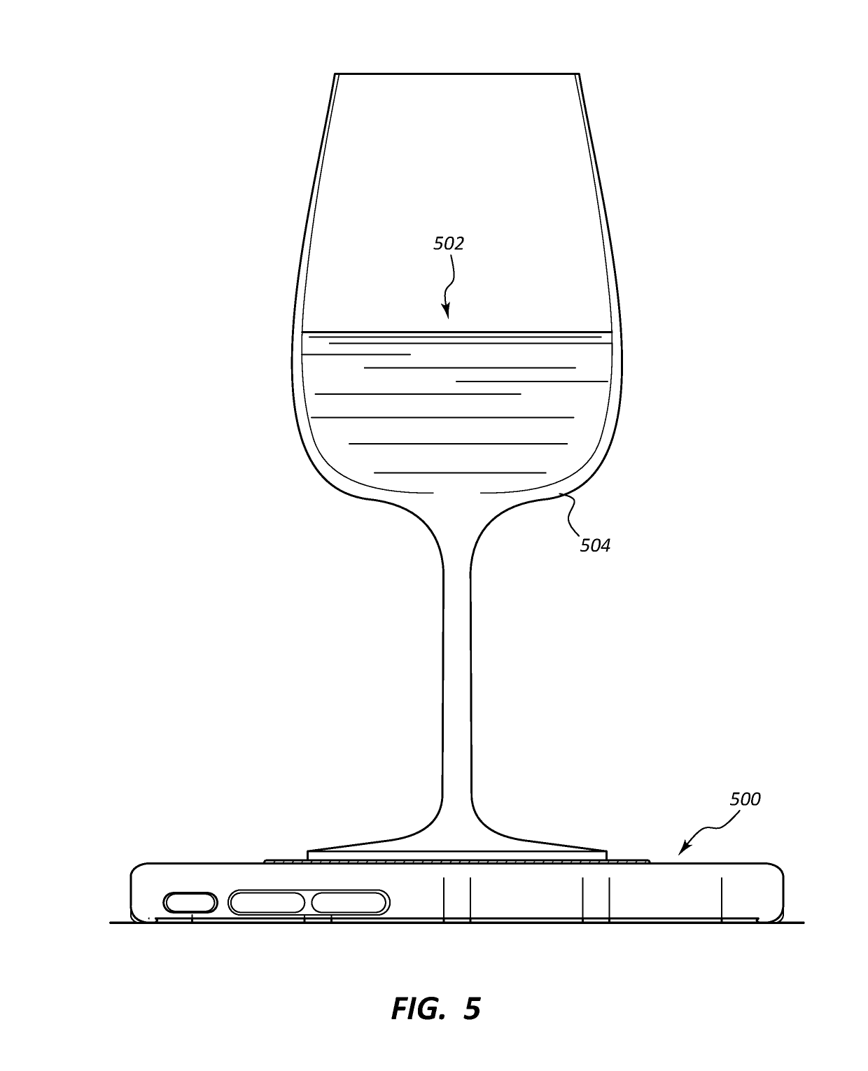

FIG. 4 depicts an example of the mobile device's display 400. In this example, a notification 402 is presented in the display 400 that indicates that if the user eats the weighed potato that his or her calorie goal for the day will be exceeded.

Any appropriate type of notification 402 may be displayed. A non-exhaustive list of notifications that may be used in accordance with the principles described herein may include progress notifications indicating how close a user is to a nutritional goal, reminder notifications, alcoholic consumption warnings, salt consumption warnings, cholesterol consumption warnings, other types of warnings, other types of notifications, or combinations thereof.

FIG. 5 depicts an example of the case 500 being used to measure the weight of a beverage 502. In this example, the beverage 502 is contained in a glass 504. The weight of the beverage 502 may be calculated by removing the weight of the glass 504. In some cases, the weight of the glass 504 or other container is removed as described in other places in the present disclosure.

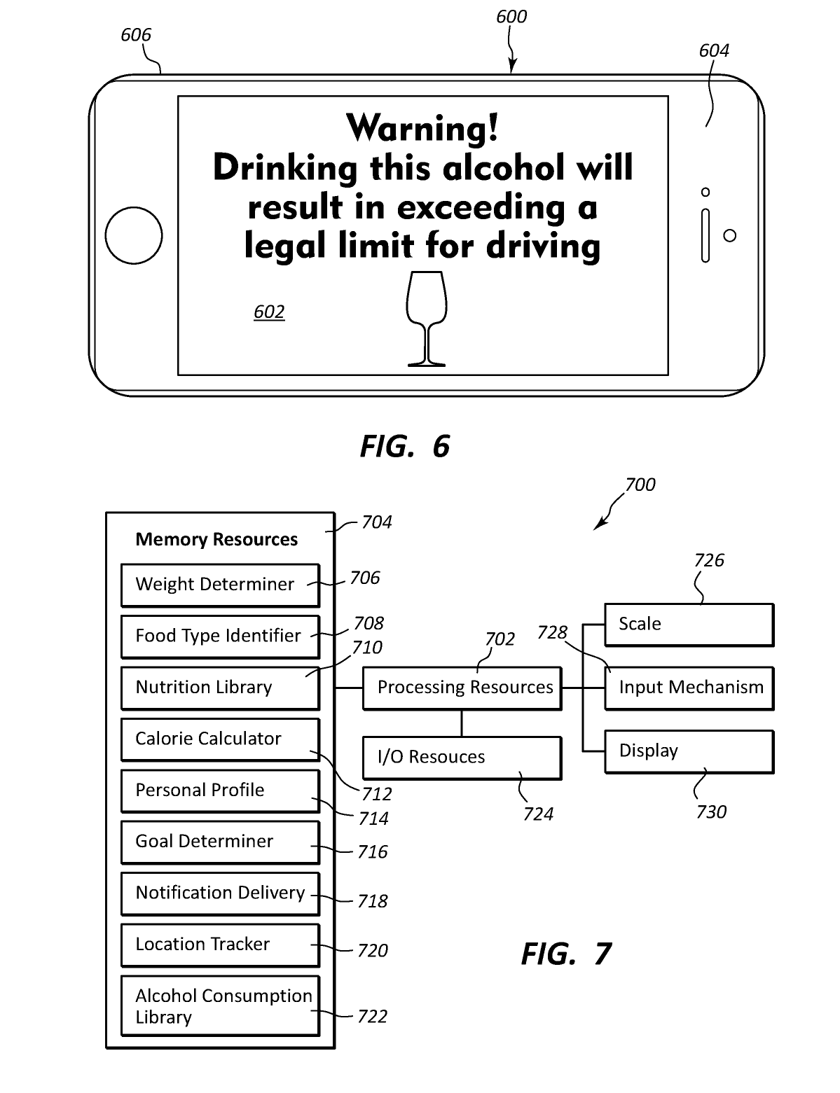

FIG. 6 depicts an example of a notification 600 being depicted in a display 602 of the mobile device 604. In this example, the notification 600 indicates that if the user drinks the beverage that the user will exceed a legal limit for driving. The case 606 or the mobile device 604 may determine the amount of alcohol in the beverage based on the measured weight and the identified type of beverage. Further, the case 606 or the mobile device 604 may also track the amount of alcohol previously consumed by the user to determine that the user has accumulatively consumed an amount of alcohol that reaches the legal limits.

FIG. 7 depicts an example of a tracking system 700. In this example, the tracking system 700 includes processing resources 702 and memory resources 704. The memory resources 704 may cause the processing resources 702 to carry out functions programmed in the memory resources 704. In this example, the memory resources 704 include a weight determiner 706, a food type identifier 708, a nutrition library 710, a calorie calculator 712, a personal profile 714, a goal determiner 716, a notification library 718, a location tracker 720, and an alcohol consumption library 722.

The processing resources 702 may be in communication with I/O resources 724, which may include a receiver, a transmitter, a transceiver, another type of communication device, or combinations thereof. Further, the processing resources 702 may be in communication with the weight scale 726, an input mechanism 728, and a display 730.

### GENERAL DESCRIPTION OF THE INVENTION

In general, the invention disclosed herein may provide an user with a convenient system for counting the number of calories that the user consumes while eating. The invention may include incorporating a scale into the case of a mobile device, such as a case for a smart phone, a case for an electronic tablet, a case for a personal electronic device, a case for a laptop, another type of mobile device, or combinations thereof. The case may include a back wall, a first side wall transversely connected to the back wall, and a second side wall transversely connected to the back wall opposite the first side wall.

The case may also include an attachment feature integrated into at least one of the first side wall and the second side wall to connect the mobile device case to a mobile device. The attachment feature may be a lip on the ends of the first and second side walls that retains the case around the mobile device. In other examples, the attachment feature may be the dimensions of the case, which cause the case to stay connected to the mobile device through a compression fit. In yet other examples, the case may be connected to the mobile device through a magnetic feature, a latch, a snap, Velcro, a cord, another type of attachment feature, an adhesive, or combinations thereof.

The case may also include a third side wall transversely attached to the back side, as well as the first side wall and the second side wall. Additionally, the case may further include a fourth side wall transversely attached to the back side, the first side wall, and the second side wall and be opposite the third side wall. But, while the examples above have been described with reference to a specific type of case for a specific type of mobile device, any appropriate type of case may be used for any appropriate type of mobile device in accordance with the principles described herein. For example, the case may include just two side walls, just three side walls, or another of appropriate number of side walls. Also, the case may include different layers. For example, the case may include an inner cover and an outer cover. These covers may be situated around the case so that the mobile device provides additional padding and protection from impacts. In some situations, the case may also include a front, transparent wall through which the display of the mobile device is visible. A non-exhaustive list of mobile devices that may be used in accordance with the principles described in the present disclosure include a smart phone, another type of phone, an iPod®, an electronic tablet, a laptop, a personal digital device, a pager, another type of mobile device, a smart watch, or combinations thereof.

A weight scale integrated into at least one of the back wall, the first side wall, and the second side wall. In some examples, the first and second side walls may be located along the length of the case, along the width of the case, along another dimension of the case, or combinations thereof. Any appropriate type of weight scale may be used in accordance with the principles described in the present disclosure. For example, the weight scale may be a load cell that is attached to the back side of the case. In those examples where the case has more than one layer, the load cell may be positioned between an inner layer of the case and an outer layer of the case. In this example, the first inner layer may be connected to the first and second side walls. The first and second side walls may be made of a material that is sufficiently rigid so that when a load is placed on the case's inner layer that the load can be transferred through the first and second side walls into the surface on which the case is being supported. In this situation, the inner layer of the case resists movement under a load. Thus, when a load is placed on the outer layer of the case, the load can compress the load cell between the inner and outer layers of the case. Under this compressive load, the load cell can determine a weight value.

In other examples, the load cell is located on an inside of the back side of the case. In this example, the load cell is positioned to push against the mobile device when a load is applied to the back side of the case. Under these circumstances, the load cell is compressed between the mobile device and the case's back wall to generate the weight value. In yet other examples, the load cell is located on an outside of the back side of the case. In this circumstance, loads may be applied directly to the load cell. When the load is applied directly to the load cell, the load cell is compressed between the object providing the load and the back side of the case.

In another example, a load cell may be incorporated into at least one of the side walls of the case. For example, a first load cell may be incorporated into the first side wall and a second load cell may be incorporated into the second side wall. When the load is placed on the back side of the case, the load is transferred through the first and second side wall so that the weight of the load can be measured with the first and second load cells.

Other types of weight scales may be incorporated into the case. For example, the strain gauge may be placed on a surface of the case or integrated into a thickness of the back side, a thickness of the first side wall, or a thickness of the second side wall. In other examples, a piezoelectric material may be incorporated into a location of the case. Other types of weight scales that may be compatible with the principles described herein include springs mechanisms, hydraulic mechanisms, pneumatic mechanisms, electronic mechanisms, balance mechanisms, magnetic mechanisms, other types of mechanisms, or combinations thereof.

The weight scale may be in communication with a transmitter, a transceiver, or another type of communication device that can send the weight measurement to mobile device or to another device. For example, the weight scale may include a wireless transmitter that is in communication with the mobile device. In other examples, the wireless transmitter may send the weight measurement to a user's smart phone, another mobile device, a laptop, a computer, a networked device, a remote device, a website, another location, or combinations thereof.

The user may access the weight measurement through the mobile device. For example, the mobile device may include a display, and the mobile device may present the weight measurement in the display. The weight measurement may be presented in the display in response to receiving the weight measurement from the case. In other examples, the weight measurement is stored on the mobile device upon receipt of the measurement from the case and is presented in the display in response to commands given by the user to display the weight measurement. In yet other examples, the weight measurement is announced through the mobile device. In these examples, the weight measurement may be audibly announced through the mobile device's speakers in response to receiving the weight measurement. In other examples, the mobile device may send an electronic message to another device, such as a text message, an email, an instant message, another type of message, or combinations thereof, in response to receiving the weight measurement, or in response to a user command. In some examples, the mobile device's response to receiving the weight measurement is determined by settings that can be selected by the user.

In some examples, an application is downloaded to the mobile device that can use the weight measurement to determine other types information based in part on the received weight measurement. This application may include a calorie determiner that determines the amount of calories that are in food that was placed on the scale. For example, a user may place the mobile device with the case on the table and place a plate of food on the case. The weight scale may record the weight measurement and send the weight measurement to mobile device.

In some cases, the mobile device may estimate the amount of calories merely based on the weight. In this example, the mobile device may determine an average amount of calories for an average amount of food and subtract the average weight of a plate. But, in other examples, the user may have an option of inputting the type of food that is on the plate. In that circumstance, the mobile device may use a look-up table or another type of library to determine the calorie density for the identified food type and multiply the type's calorie density by the weight to determine the calorie amount on the plate. In this example, an estimated weight of the plate may be removed.

In yet other examples, the type of food may be identified and the weight of the plate plus the food may be measured with the weight scale. This amount may be sent to the mobile device for storage. After the user is done eating, the weight scale can record the new weight of the plate plus any remaining amount of food. In this circumstance, the weight after eating can be subtracted from the weight of the plate before eating. As a result, the user can have a more precise weight of the food consumed. The mobile device may use the weight differences from before and after eating and multiply the difference by the calorie density of the identified food type to determine the actual number of calories consumed. In some cases, the plate of food may remain on the mobile device's case so that the weight difference is determined as the user is eating. In this circumstance, the weight difference can be determined automatically, and the user is spared from having to make multiple measurements. In other examples, the user takes the plate off of the scale while eating and puts the plate back onto the scale after he or she has finished eating.

Additionally, in other circumstances, the user can place the plate on the scale and calibrate the weight scale to zero. Then the user may add a food to the plate that is identified as a specific type of food. The added weight can be associated with that specific food type. The mobile device may multiply that food type's calorie density by the added weight amount. Additionally, another type of food may be added onto the plate after the first food is added. In this circumstance, the second food type may also be identified, and the added weight may be associated with the second type of food. Again, the mobile device may multiply the second food type's calorie density with the added weight to determine the calories associated with the second food type. This process may be repeated until all of the food types have been added to the plate. Each of the calories amounts associated with each of the foods on the plate can be added to determine the total calorie amount on the plate. While the examples above have been described with reference to specific procedures that can be implemented with the mobile device to calculate the calorie amount, any appropriate procedure for calculating the total calorie amount with the mobile device may be used in accordance to the principles described in the present disclosure.

While the above examples have been described with reference to determining the amount of calories associated with the food on a plate, other types of nutritional information can be determined with the principles described above. For example, the principles described above can be used to determine the amount of fiber, carbohydrates, fats, oils, vitamins, salt, sugar, minerals, electrolytes, other nutrients, cholesterol, other food constituents, or combinations thereof. The notifications may be sent to the mobile device to be presented in the mobile device's display. In other examples, the notifications are sent to an independent mobile device. For example, the message may be sent and presented to the user in a smart watch. In this example, the user may view the notification without having to remove the food from the weight scale.

The type of food on the scale may be identified by the user inputting the type of food into the mobile device. In some cases, the user types the type of food into the mobile device. In other examples, the user can select an icon the represents the food type. Further, in some cases, the user can verbally speak the type of food to identify the food type. In an additional example, an image of the food is taken and analyzed by the case and/or the mobile device to determine the food type. The camera that takes the image of the food may be part of the mobile device, or the camera may be part of another device independent of the mobile device.

In some cases, the identified food is a beverage. In examples where the beverage contains alcohol, the user's alcohol consumption can be determined based on the beverage's weight. In those circumstances where the user appears to be reaching a legal limit for driving, the scale and/or mobile device may cause a notification to be presented in the mobile device's display to indicating that the user has reached the legal limit driving or how close the user is to the legal limit.

The nutritional information, including alcoholic information, can be determined by consulting a look-up table in a library that associates the nutritional information of the identified food by weight. In some circumstances, multiple types of food may be weighed with the case. In those circumstances, the user may add a single food type at a time so that the weights of each food may be tracked separately with the case and/or mobile device.

The user may set a goal to consume more or less than a specific number of calories. This goal may be inputted into the system through any appropriate input mechanism. Notifications regarding the user's goals may be sent to the mobile device as the food amounts are weighed or after the user has eaten the food on his or her plate.

The calorie number, the volume of food, the type of food, other nutritional data, or combinations thereof may be sent to a remote database for storage. The remote storage may be accessible to the user over a network, such as the internet. The user may access the records of his or her eating history, determine eating patterns and habits and make adjustments. In some situations, this nutritional information may be stored in a database or be accessible to a user profile of an exercise program. An example of a user program that may be compatible with the principles described herein can be found at www.ifit.com, which is administered through Icon Health and Fitness, Inc. located in Logan, Utah, U.S.A. In some examples, this nutritional information may be made public at the user's request or be made viewable to certain people. These individuals may give the user advise about improving eating habits. In other examples, the user may compete with others to have lower amounts of calories within a time period or to achieve a different type of nutritional goal.

In some examples, a camera may be attached to the user to determine to food type that the user is measuring. This camera may be attached to the user's eye wear so that the camera can capture an image of the food on the scale. Based on the images, the food type may be determined. The camera may be positioned at any appropriate location. For example, the camera may be worn by the user on his or her eye wear, a hat, a scarf, jewelry, a necklace, a wearable device, a shirt, a coat, another article of clothing, an adhesive, teeth braces, another mechanism or combinations thereof.

The camera may have a processor and logic to interpret the characteristics of the food to determine the food type. In other situations, the camera may send the images to another device to interpret the data. In some examples, the camera may send at least a portion of the data to the mobile device for processing or to be relayed to another device for processing. In some cases, the data may be modified before being sent to a remote device. For example, the camera may compress data, filter data, or otherwise modify the data. In other examples, the camera includes minimal logic to reduce the amount of power needed to operate the camera.

The tracking system may include a combination of hardware and programmed instructions for executing the functions of the tracking system. The tracking system may include processing resources that are in communication with memory resources. Processing resources include at least one processor and other resources used to process the programmed instructions. As described herein, the memory resources may represent generally any memory capable of storing data such as programmed instructions or data structures used by the tracking system. The programmed instructions and data structures may include a weight determiner, a food type identifier, a nutrition library, a calorie calculator, a personal profile, a goal determiner, a notification library, a location tracker, and an alcohol consumption library.

The processing resources may include I/O resources that are capable of being in communication with a remote device that stores the user information, eating history, workout history, external resources, databases or combinations thereof. The remote device may be a mobile device, a cloud based device, a computing device, another type of device, or combinations thereof. In some examples, the system communicates with the remote device through a mobile device which relays communications between the tracking system and the remote device. In other examples, the mobile device has access to information about the user. In some cases, the remote device collects information about the user throughout the day, such as tracking calories, exercise, activity level, sleep, other types of information, or combination thereof. In one example, a treadmill used by the user may send information to the remote device indicating how long the user exercised, the number of calories burned by the user, the average heart rate of the user during the workout, other types of information about the workout, or combinations thereof.

The remote device may execute a program that can provide useful information to the tracking system. An example of a program that may be compatible with the principles described herein includes the iFit program which is available through www.ifit.com identified above. An example of a program that may be compatible with the principles described in this disclosure are described in U.S. Pat. No. 7,980,996 issued to Paul Hickman. U.S. Pat. No. 7,980,996 is herein incorporated by reference for all that it discloses. In some examples, the user information accessible through the remote device includes the user's age, gender, body composition, height, weight, health conditions, other types of information, or combinations thereof.

The processing resources, memory resources, and remote devices may communicate over any appropriate network and/or protocol through the input/output resources. In some examples, the input/output resources includes a transmitter, a receiver, a transceiver, or another communication device for wired and/or wireless communications. For example, these devices may be capable of communicating using the ZigBee protocol, Z-Wave protocol, BlueTooth protocol, Wi-Fi protocol, Global System for Mobile Communications (GSM) standard, another standard, or combinations thereof. In other examples, the user can directly input some information into the tracking system through a digital input/output mechanism, a mechanical input/output mechanism, another type of mechanism, or combinations thereof.

The memory resources may include a computer readable storage medium that contains computer readable program code to cause tasks to be executed by the processing resources. The computer readable storage medium may be a tangible and/or non-transitory storage medium. The computer readable storage medium may be any appropriate storage medium that is not a transmission storage medium. A non-exhaustive list of computer readable storage medium types includes non-volatile memory, volatile memory, random access memory, write only memory, flash memory, electrically erasable program read only memory, magnetic based memory, other types of memory, or combinations thereof.

The weight determiner represents programmed instructions that, when executed, cause the processing resources to weigh the food. A weight scale may measure an analog signal that varies based on the weight loaded to the scale. In some cases, the signal's output is related to the overall weight. This output signal may be used as at least one factor in determining the food's weight. Other factors may include communications that the food is in a container, a weight amount to subtract from an overall weight that represents the container and/or other non-food weight being measured.

In some examples, the food type identifier represents programmed instructions that, when executed, cause the processing resources to determine the type of food being weighed. In some cases, a single type of food is being weighed while in other examples, multiple types of food are being weighed. In some cases, the user inputs the type of food. In other examples, other mechanisms for indicating the type of food may be used such as capturing an image with a camera, using a scanner, using a bar code, selecting a food from a database, another type of mechanism, or combinations thereof.

The food type may be associated with a nutrition library that associates the food type with nutritional information by weight. The nutritional information may include calories, proteins, carbohydrates, fiber, cholesterol, sugars, fats, vitamins, minerals, iron, alcohol content, other types of nutritional information, or combinations thereof.

The calorie calculator represents programmed instructions that, when executed, cause the processing resources to determine the calories in the food. In one example, the calorie calculator may consult the nutritional library and multiply the number of calories by the weight. In those examples where multiple types of foods are being weighed simultaneously, each of the calories for each of the food types may be measured separately and added together to determine the overall calorie amount.

The user may have a personal profile that is associated with an activity and/or calorie goal tracker. The user's weight loss goals, weight gain goals, fiber goals, other type of health goals, and so forth may be included in the personal profile. The personal profile may be stored in the mobile device or at a remote location accessible through a wireless signal.

The goal determiner represents programmed instructions that, when executed, cause the processing resources to determine the user's goals. In some examples, the goal determiner consults the user's personal profile to determine the user's goals.

The notification delivery may determine the appropriate type of message to deliver to the user based on the nutritional information associated with the measured food. In some examples, the notification may be associated with the user's health goals. In other examples, the notification may be associated with a health risk, an allergy risk, another type of risk, another type of information, or combinations thereof.

The notification delivery may send notifications to the user through any appropriate mechanism. For example, the notification generator may cause an email, a text message, another type of written message, or combinations thereof to be sent to the user. In other examples, the notification generator may cause an audible message to be spoken to the user. In yet other examples, the notification generator may cause a vibration or another type of haptic event to occur to indicate to the user a notification related to the user's goal. Further, the notification may be presented to the user in the mobile device's screen.

The location tracker represents programmed instructions that, when executed, cause the processing resources to determine the location of the user. In those circumstances where the user is consuming alcohol, the location tracker may identify which legal jurisdictions that the user is presently located within to determine which alcohol consumption laws are currently applicable to the user.

The alcohol consumption library may include the alcohol consumption laws by state, city, country, or other geographic region. Notifications about the alcohol consumption may be based in part on the information in alcohol consumption library.

While the examples above have been described with reference to determining a number of calories being consumed by the user, the principles above may be applied to determining other types of information about the food being consumed by the user. For example, the principles described in the present disclosure may be used to determine the amounts of protein, fat, salt, vitamins, fiber, other types constituents, or combinations thereof. The nutritional information may be reported to the user through the same or similar mechanisms used to report the calorie information to the user. The nutritional information may be ascertained through appropriate libraries that associate the food constituents with the food type per food volume. Further, the user may set goals pertaining to these other nutritional aspects as well. For example, the user may set goals to stay under a certain amount of salt or to consume at least a specific number of grams of protein in a day. The notification delivery may notify the user accordingly for these salt intake and protein consumption goals as described above.

Further, the memory resources may be part of an installation package. In response to installing the installation package, the programmed instructions of the memory resources may be downloaded from the installation package's source, such as a portable medium, a server, a remote network location, another location, or combinations thereof. Portable memory media that are compatible with the principles described herein include DVDs, CDs, flash memory, portable disks, magnetic disks, optical disks, other forms of portable memory, or combinations thereof. In other examples, the program instructions are already installed. Here, the memory resources can include integrated memory such as a hard drive, a solid state hard drive, or the like.

In some examples, the processing resources and the memory resources are located within the scale, the case of the mobile device, the mobile device, an external device, another type of device, or combinations thereof. The memory resources may be part of any of these device's main memory, caches, registers, non-volatile memory, or elsewhere in their memory hierarchy. Alternatively, the memory resources may be in communication with the processing resources over a network. Further, data structures, such as libraries or databases containing user and/or workout information, may be accessed from a remote location over a network connection while the programmed instructions are located locally. Thus, the tracking system may be implemented with the case, the scale, the mobile device, a wearable computing device, a head mounted device, a server, a collection of servers, a networked device, a watch, or combinations thereof. The implementation may occur through input/output mechanisms, such as push buttons, touch screen buttons, voice commands, dials, levers, other types of input/output mechanisms, or combinations thereof. Any appropriate type of wearable device may include, but are not limited to glasses, arm bands, leg bands, torso bands, head bands, chest straps, wrist watches, belts, earrings, nose rings, other types of rings, necklaces, garment integrated devices, other types of devices, or combinations thereof.

The case may be made of any appropriate material. In some examples, the case for the mobile device may include a thermal insulating material incorporated into the case. In these examples, heat from a hot plate may be reflected away or otherwise insulated from reaching the mobile device. A non-exhaustive list of thermal insulating materials that mat be compatible with the principles described herein include polyurethane foam, polystyrene, perlite, fiberglass, cork, glass, vermiculite, phenolic foam, other types of materials, or combinations thereof.

In some situations, thee mobile device may include a water resistant encapsulating material surrounding the case. The encapsulating material may protect the mobile device in the event that a beverage or food is spilled on the case in the process of using the case to measure the weight of the food and/or beverage. A non-exhaustive list of water resistance encapsulating materials may include resins, epoxy, polyethylene, a polymer, another type of water resistant encapsulation material, or combinations thereof.

What is claimed is:

1. A mobile device case, comprising:
a back wall;
a first side wall transversely connected to the back wall;
a second side wall transversely connected to the back wall opposite the first side wall;
an attachment feature integrated into at least one of the first side wall and the second side wall to connect the mobile device case to a mobile device; and
a weight scale integrated into at least one of the back wall, the first side wall, and the second side wall.

2. The mobile device case of claim 1, further comprising a transmitter to communicate with the mobile device.

3. The mobile device case of claim 1, further comprising a memory and a processor, wherein the memory comprises programmed instructions to cause the processor to send a weight measured with the weight scale to the mobile device.

4. The mobile device case of claim 3, wherein the programmed instructions further cause the processor to receive a food type from the mobile device.

5. The mobile device case of claim 4, wherein the programmed instructions further cause the processor to multiply a measured weight with a calorie amount associated with the food type to determine a calorie count.

6. The mobile device case of claim 5, wherein the programmed instructions further cause the processor to send a notification based one the calorie count.

7. The mobile device case of claim 6, wherein the notification suggests that a user modify an amount of food being measured with the weight scale.

8. The mobile device case of claim 3, wherein the programmed instructions further cause the processor to send a warning to the mobile device when the weight measured with the weight scale and associated with an alcoholic beverage exceeds a predetermined weight.

9. The mobile device case of claim 1, further comprising a thermal insulating material incorporated into the back wall.

10. The mobile device case of claim 1, further comprising a water resistant encapsulating material surrounding the weight scale.

11. A method for determining an indigested amount of calories, comprising:
receiving an input of identifying a food type into a mobile device;
receiving a container of food on the mobile device where the mobile device is attached to a case that incorporates a weight scale;
measuring a before measurement of a weight of the container of the food with the weight scale before eating at least a portion of the food; and
measuring an after measurement of the weight of the container of the food with the weight scale after eating the at least portion of the food.

12. The method of claim 11, further comprising determining a difference between the weight of the food before and after eating.

13. The method of claim 12, further comprising multiplying the difference by a calorie amount associated with the food type to determine a calorie count.

14. The method of claim 13, further comprising communicating a notification based on the calorie count.

15. The method of claim 13, further comprising communicating a warning when the calorie count exceeds a predetermined threshold when the food type is an alcoholic beverage.

16. A mobile device, comprising:
a case;
a weight scale integrated into the case;
a scale transmitter in communication with the weight scale;
a mobile device transmitter in communication with memory and a processor of mobile device;
the memory comprising programmed instructions that cause the processor to:
receive an input of identifying a food type into a mobile device;
receive a container of food on the mobile device where the mobile device is attached to the case that incorporates the weight scale;
receive a before measurement of a weight of the container of the food with the weight scale before eating at least a portion of the food; and
receive an after measurement of the weight of the container of the food with the weight scale after eating the at least portion of the food.

17. The mobile device of claim 16, further comprising a thermal insulating material incorporated into the case.

18. The mobile device of claim 16, further comprising a water resistant encapsulating material surrounding the case.
